(19) United States
(12) Patent Application Publication
(10) Pub. No.: US 2025/0143461 A1
(43) Pub. Date: May 8, 2025

(54) METHOD FOR CONNECTING A FRONT PANEL TO A DRAWER LATERAL WALL

(71) Applicant: Julius Blum GmbH, Hoechst (AT)

(72) Inventors: Gerald SPERGER, Hard (AT); Claudio Gmeiner, Alberschwende (AT); Benjamin Von Der Wellen, Bludenz (AT); Michael Raffeiner, Hard (AT)

(21) Appl. No.: 19/018,651

(22) Filed: Jan. 13, 2025

Related U.S. Application Data
(63) Continuation of application No. PCT/AT2023/060218, filed on Jul. 6, 2023.

(30) Foreign Application Priority Data
Jul. 21, 2022 (AT) A 50550/2022

(51) Int. Cl. A47B 88/95; A47B 88/407; B23B 47/28

(52) U.S. Cl. CPC A47B 88/95; A47B 88/407; B23B 47/287; A47B 2088/952

(57) ABSTRACT

In a method of mounting a front panel on a drawer side wall for a drawer, the drawer side wall has a connecting device for connecting a front panel to the drawer side wall, an end face facing the front panel to be connected, and a marking device for marking a position for a drill hole in the front panel, and the marking device projects beyond the end face of the drawer side wall. The method includes: marking a position for a drill hole on the front panel by the one marking device of the drawer side wall, making a drill hole in the front panel at the marked position, and mounting a front panel holding device on the front panel via the drilled hole. The front panel is then connected to the drawer side wall by connecting the front panel holding device to the connecting device.

The present application is a continuation of International Application PCT/AT2023/060218 filed on Jul. 6, 2023. Thus, all of the subject matter of International Application PCT/AT2023/060218 is incorporated herein by reference.

### BACKGROUND OF THE INVENTION

The invention relates to a method for mounting at least one front panel on at least one drawer side wall.

When mounting a front panel on a drawer side wall, it is important that the front panel is precisely aligned relative to the drawer side wall in order to achieve a uniform joint pattern. One challenge is to place holes for connecting elements in the front panel in the correct positions, wherein the positions are usually measured manually, which is time-consuming and can be associated with measurement inaccuracies.

DE 202011106765 U1 discloses a front wall fitting with a front wall holder attached to it, with fastening screws inserted into the front wall bracket.

EP 0439748 A2 discloses a solution in which the front wall fitting must first be connected to the front wall and then the front wall fitting is connected to the front wall holder. Without the front wall, the front wall fitting could not be held in position by the front wall holder.

### SUMMARY OF THE INVENTION

The object of the present invention is to provide a method for mounting at least one front panel on at least one drawer side wall, which method is improved compared to the prior art, wherein the disadvantages known from the prior art are at least partially eliminated.

If a front panel is to be mounted on the drawer side wall, a fitter only has to align the front panel relative to the drawer side wall, and the at least one position for a drill hole in the front panel is automatically marked by means of the at least one marking device. Therefore, time-consuming and potentially inaccurate position measurements are no longer necessary. In a subsequent step, the hole can be drilled into the front panel at the marked position.

Accordingly, the inventor have provided a method for mounting at least one front panel on at least one drawer side wall, which uses at least one marking device for marking at least one position for a drill hole in the front panel, in which the marking device projects beyond the front side of the drawer side wall. The method includes: at least one position for a drill hole is marked on the front panel by the at least one marking device of the drawer side wall, and preferably at least one marker of the marking device comes into contact with the front panel at the position to be marked. At least one drill hole is made in the front panel at the at least one marked position, and at least one front panel holding device, in form of the at least one marking device, is mounted on the front panel via at least one fastening element, preferably in the form of a screw, via the at least one drilled hole. The front panel is then connected to the at least one drawer side wall by connecting the front panel holding device to the at least one connecting device.

According to a preferred embodiment, the marking device has at least one marker projecting beyond the front side of the drawer side wall, and the marker has at least one, preferably substantially conical, tip which penetrates into a material of the front panel to be connected at the position to be marked.

Alternatively or additionally, the marking device has at least two markers projecting beyond the front side of the drawer side wall, and preferably the markers are spaced apart from one another in a direction transverse to a longitudinal direction of the drawer side wall. In this way, at least two positions for a drill hole in the front panel can be marked simultaneously.

It has proven to be particularly advantageous that the marking device not only serves to mark at least one position for a drill hole in the front panel, but simultaneously fulfills at least one other function. Thus, the marking device is designed as a front panel holding device in order to connect the front panel to the drawer side wall via the at least one connecting device, and/or the marking device is designed as a drawer bottom support device in order to support a drawer bottom, preferably centrally, on the front panel to be connected, and/or the marking device can be mounted on the front panel to be connected, preferably by screwing and/or plugging.

Thus, according to advantageous embodiments of the method, the at least one marking device is detached from the at least one drawer side wall in a further step, and/or at least one front panel holding device, preferably the at least one marking device, is mounted on the front panel in a further step via at least one fastening element, preferably in the form of a screw, via the at least one drill hole. Preferably, the front panel is then connected to the at least one drawer side wall by connecting the front panel holding device to the at least one connecting device, and/or at least one drawer bottom support device, preferably the at least one marking device, is connected to the front panel, preferably centrally, in a further step and at least one drawer bottom is supported on the drawer bottom support device.

### BRIEF DESCRIPTION OF THE DRAWINGS

Further details and advantages of the invention are explained in more detail below with reference to the drawings, in which:

FIG. 1 shows a drawer with a front panel to be mounted in a perspective view,

FIGS. 2-4 show an enlarged section of FIG. 1 to illustrate the mounting of the front panel,

FIG. 5 shows an arrangement composed of a drawer side wall and a drawer extraction guide in a perspective view,

FIGS. 6-8 show a first exemplary embodiment of a connecting device for connecting a front panel to the drawer side wall, in which FIG. 6 shows a perspective view, FIG. 8 an exploded view, and FIG. 7 the adjustment of a connecting element relative to the connecting device,

FIGS. 9-11 are a sequence of figures to illustrate the connection of the connecting element with the connecting device according to the first exemplary embodiment, each in a cross-sectional view,

FIGS. 12, 13 show a second exemplary embodiment of a connecting device for connecting a front panel to the drawer side wall, in which FIG. 12 showing a perspective view and FIG. 13 an exploded view,

FIGS. 14-17 show a sequence of figures to illustrate the connection of the connecting element with the connecting device according to the second exemplary embodiment, each in a cross-sectional view,

FIGS. 18, 19 show the connecting device according to the second exemplary embodiment with an inserted marking device in the form of a clamp in a cross-sectional view, the marking device being shown in isolation in FIG. 19, and

FIG. 20 shows a drawer in a perspective view from below, wherein the marking device of FIGS. 18 and 19 supports the drawer bottom.

### DETAILED DESCRIPTION OF THE INVENTION

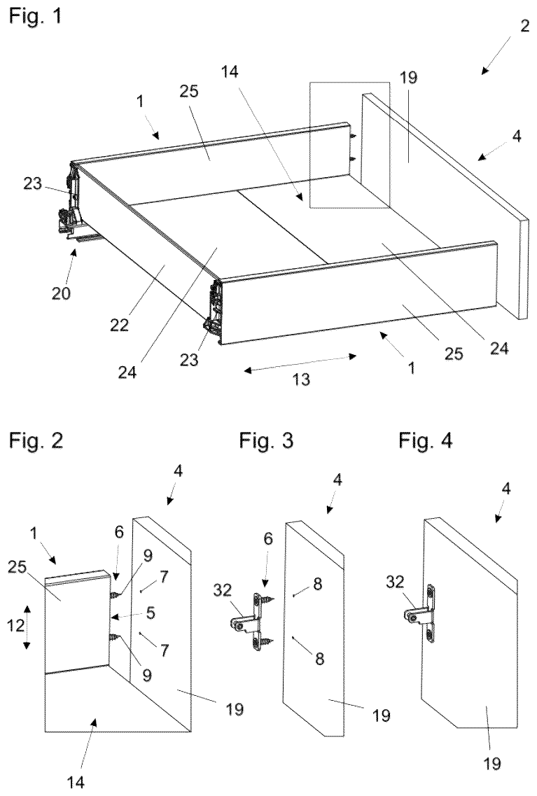

FIG. 1. shows a drawer 2 with a front panel 4 to be mounted in a perspective view, FIGS. 2 to 4 show the section marked in FIG. 1 to illustrate the mounting of the front panel 4.

The drawer 2 comprises a drawer side wall 1 with at least one connecting device 3 for, preferably detachably, connecting a front panel 4 to the drawer side wall 1, wherein the drawer side wall 1 has an end face 5 facing the front panel 4 to be connected. The drawer side wall 1 has at least one marking device 6 for marking at least one position 7 for a drill hole 8 in the front panel 4, wherein the marking device 6 projects beyond the front side 5 of the drawer side wall 1.

The drawer side wall 1 can comprise at least one hollow profile 25 in which the connecting device 3 is arranged at least in some portions.

The drawer 2 comprises a drawer bottom 14 that can be connected to the drawer side wall 1 and/or the front panel 4. The drawer bottom 14 can be divided into segments 24, e.g. two segments 24.

The marking device 6 has at least one marker 9 projecting beyond the front side 5 of the drawer side wall 1. The marker 9 has at least one, preferably substantially conical, tip that can penetrate into a material of the front panel 4 to be connected and is part of a fastening element, preferably in the form of a screw, a nail, or a clamp. In the case shown, the marker 9 is part of a fastening element in the form of a screw.

As in the case shown, the marking device 6 can have two markers 9 projecting beyond the front side 5 of the drawer side wall 1, wherein the markers 9 are spaced apart from one another in a direction 12 transverse to a longitudinal direction 13 of the drawer side wall 1. The marking device 6 can be mounted on the front panel 4 to be connected, in the specific case shown by screws.

The marking device 6 is designed as a front panel holding device in order to connect the front panel 4 to the drawer side wall 1 via the at least one connecting device 3.

The marking device 6 can comprise at least one connecting element 32, which has for example a U-shaped cross-section, for example. The screws or the markers 9 can be mounted on the connecting element 32.

In a state connected via the at least one connecting device 3, the front side 5 of the drawer side wall 1 contacts an inner side 19 of the front panel 4 facing the drawer side wall 1, at least in portions.

In order to mount the front panel 4 on the at least one drawer side wall 1, it can be provided according to a preferred exemplary embodiment of the invention that at least one position 7 for a drill hole 8 on the front panel 4 is marked by means of the at least one marking device 6 of the drawer side wall 1, wherein the at least one marker 9 of the marking device 6 comes into contact with the front panel 4 at the position 7 to be marked (see FIG. 2). In a further step, at least one drill hole 8 is made in the front panel 4 at the at least one marked position 7 (FIG. 3).

In a further step, the at least one marking device 6 is detached from the at least one drawer side wall 1 (see FIG. 3).

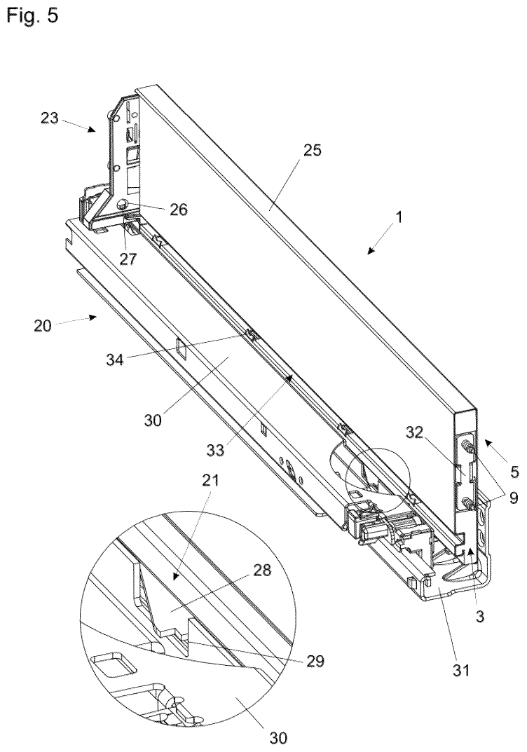

The at least one marking device 6, which is simultaneously designed as a front panel holding device, is mounted in a further step via at least one fastening element, preferably in the form of a screw, via the at least one drill hole 8 on the front panel 4 (cf. FIG. 4), wherein the front panel 4 is then connected to the at least one drawer side wall 1 by connecting the front panel holding device to the at least one connecting device 3.

FIG. 5 shows an arrangement composed of a drawer side wall 1 and a drawer extraction guide in a perspective view.

The drawer extraction guide 20 has a body rail 31 to be connected to a furniture body and a drawer rail 30 which is mounted so as to be movable relative thereto.

At least one coupling device 21 is provided, with which the drawer side wall 1 can be coupled, preferably detachably, to the drawer extraction guide 20. The drawer rail 30 is shown broken open in the area of the coupling device 21 for better visibility. The coupling device 21 can have a coupling lever 28 and a coupling contour 29 cooperating therewith, wherein the coupling lever 28 can be formed, for example, on the drawer side wall 1 and the coupling contour 29 on the drawer rail 30, or vice versa.

The arrangement can comprise a rear wall 22 that can be arranged parallel to the front panel, wherein the drawer side wall 1 comprises at least one rear wall holder 23, via which the rear wall 22 can be connected to the drawer side wall 1, preferably detachably. The rear wall holder 23 can be arranged at least partially in the drawer side wall 1.

The drawer side wall 1 can be connected to the drawer extraction guide 20 via the rear wall holder 23. For this purpose, it can be provided that a hook 27 arranged on the drawer rail 30, preferably in an adjustable manner, engages in an opening 26 in the rear wall holder 23.

A groove 33 can be arranged in the drawer side wall 1, in which an edge of a drawer bottom 14 can be mounted. Means, e.g. barbs 34, can be provided for fastening the drawer bottom 14 to the drawer side wall 1 or the groove 33, preferably without the use of tools.

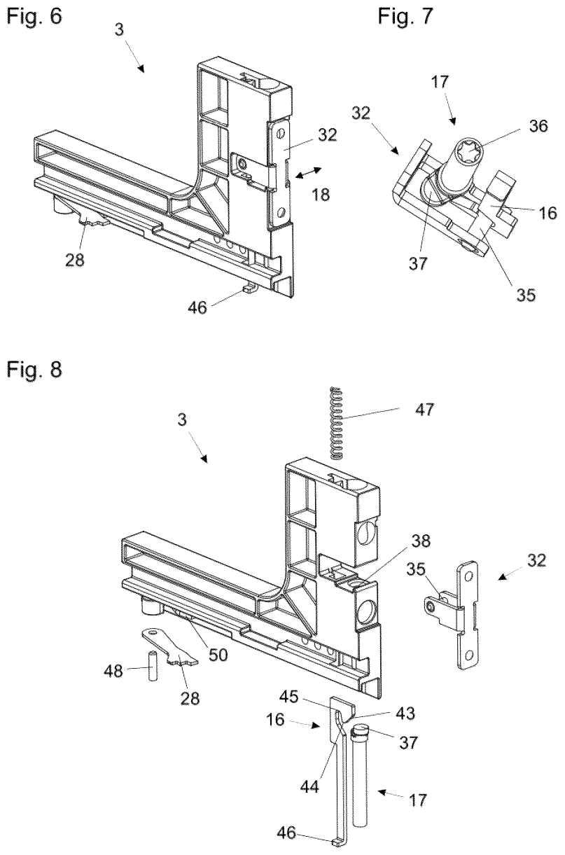

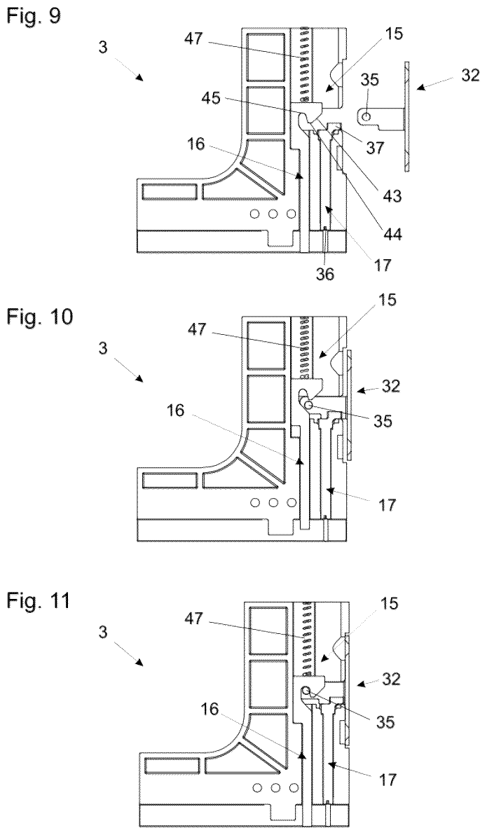

FIGS. 6-8 show a first exemplary embodiment of a connecting device 3 for connecting a front panel 4 to the drawer side wall 1, wherein FIG. 6 shows a perspective view, FIG. 8 an exploded view and FIG. 7 the adjustment of a connecting element relative to the connecting device 3, FIGS. 9 to 11 show a sequence of figures to illustrate the connection of the connecting element 32 to the connecting device 3.

The connecting device 3 has at least one fastening device 15, via which the marking device 6 or the connecting element 32 is fastened, preferably detachably, to and/or in the connecting device 3.

For this purpose, the fastening device 15 can have at least one spring-loaded and displaceably mounted fastening latch 16 as in the case shown. A spring 47 is provided, which applies a force to the fastening latch 16 in the direction of a fastening position.

To connect the connecting element 32 to the fastening latch 16, a bolt 35 of the connecting element 32 comes into contact with an inclined surface 43 of the fastening latch 16, wherein the fastening latch 16 is urged against the force of the spring 47 from the fastening position into a release position (cf. FIG. 10). The bolt 35 overcomes a nose 44 and, under the influence of the spring force, enters a recess 45 (see FIG. 11). The fastening latch 16 is moved back into the fastening position.

For unlocking, the fastening latch 16 has an actuator 46 on its underside.

At least one adjustment device 17 is provided, with which the marking device 6 can be adjusted at least in a direction 18 transverse to a longitudinal direction 13 of the drawer side wall 1 relative to the drawer side wall 1.

The adjustment device 17 can, as in the case shown, have a cylindrical rod, which comprises an actuating element 36 at a first end and an eccentric 37 at a second end opposite the first end. The rod can be mounted in a corresponding recess 38 of a base body of the connecting device 3. When the adjustment device 17 is actuated, the eccentric 37, which is in engagement with the connecting element 32 or can be brought into engagement with it, displaces the connecting element 32 in a direction 18 transverse to a longitudinal direction 13 of the drawer side wall 1 relative to the drawer side wall 1.

The coupling lever 28 is mounted on the connecting device 3 so as to be rotatable about a rotation axis 48. A spring element 50 is provided, which applies a force to the coupling lever 28 in the direction of a coupling position.

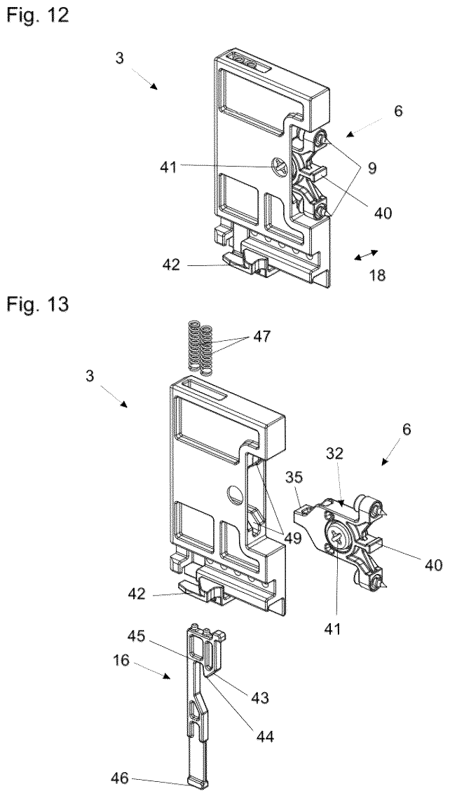

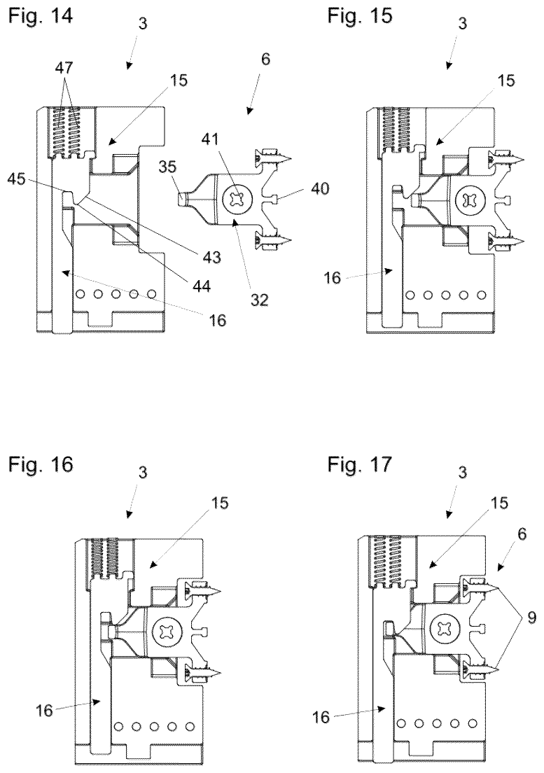

FIGS. 12 and 13 show a second exemplary embodiment of a connecting device 3 for connecting a front panel 4 to the drawer side wall 1. FIGS. 14 to 17 show a sequence of figures to illustrate the connection of a connecting element 32 to the connecting device 3.

The functional principle and basic structure of the connecting device 3 are essentially the same as those of the connecting device 3 according to the first exemplary embodiment.

The connecting element 32 comprises a base body made of plastic. Two screws, which serve as markers 9 in the sense of the present invention, are mounted in the base body. A support foot which can be placed on the front panel 4 to be connected is arranged between the markers 9.

At least one adjustment device 17 is provided, with which the marking device 6 can be adjusted at least in a direction 18 transverse to a longitudinal direction 13 of the drawer side wall 1 relative to the drawer side wall 1. The adjustment device 17 comprises an adjustment screw 41, which is rotatably mounted in the base body of the connecting element 32.

For coupling the drawer side wall 1 to a drawer extraction guide 20, the connecting device 3 has at least one coupling element 42, which can be gripped around by a coupling lever mounted on the drawer extraction guide 20 for coupling.

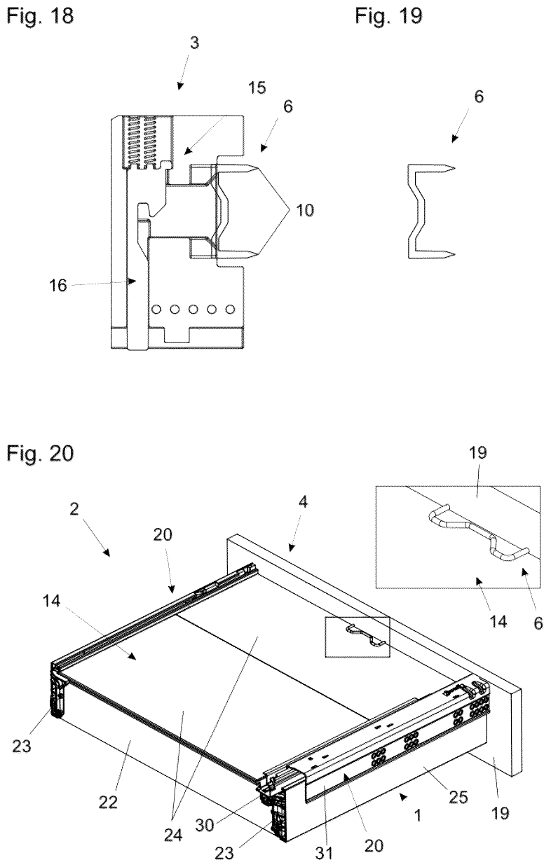

FIGS. 18 and 19 show the connecting device 3 according to the second exemplary embodiment with an inserted marking device 6 in the form of a clamp. FIG. 20 shows a drawer 2 in a perspective view from below, wherein the marking device 6 is inserted into the front panel 4 and supports the drawer bottom 14 in the middle.

The marking device 6 is designed as a drawer bottom support device in order to support a drawer bottom 14, preferably centrally, on the front panel 4 to be connected.

The marking device 6 can be inserted into the connecting device 3 in a first operating position for marking at least one position 7 for a drill hole 8 in the front panel 4 (see FIG. 18). For this purpose, the connecting device 3 can have a receiving contour 49 (see FIG. 13).

The marking device 6 can then be removed from the connecting device 3 (see FIG. 19) and connected to the front panel 4, preferably centrally, preferably by inserting the tips 10 into corresponding holes. The marking device 6 can support at least one drawer bottom 14.

1. A method of mounting at least one front panel on at least one drawer side wall for a drawer, wherein the drawer side wall has at least one connecting device for, preferably detachably, connecting a front panel to the drawer side wall, an end face facing the front panel to be connected, and at least one marking device for marking at least one position for a drill hole in the front panel, wherein the marking device projects beyond the end face of the drawer side wall, the method comprising:
marking at least one position for a drill hole on the front panel by the at least one marking device of the drawer side wall, preferably wherein at least one marker of the marking device comes into contact with the front panel at the position to be marked,
making at least one drill hole in the front panel at the at least one marked position, and
mounting at least one front panel holding device, formed as the at least one marking device, on the front panel via at least one fastening element, preferably in the form of a screw, via the at least one drilled hole, and then
connecting the front panel to the at least one drawer side wall by connecting the front panel holding device to the at least one connecting device.

2. The method according to claim 1, wherein the at least one marking device is detached from the at least one drawer side wall in a further step.

3. The method according to claim 1, wherein at least one drawer bottom support device, preferably the at least one marking device, is connected to the front panel, preferably centrally, in a further step and at least one drawer bottom is supported on the drawer bottom support device.

4. The method according to claim 1, wherein the marking device has at least one marker projecting beyond the front side of the drawer side wall, wherein the marker has at least one, preferably substantially conical, tip which penetrates into a material of the front panel to be connected at the position to be marked.

5. The method according to claim 1, wherein the marking device has at least two markers projecting beyond the front side of the drawer side wall, preferably wherein the markers are spaced apart from one another in a direction transverse to a longitudinal direction of the drawer side wall, wherein at least two positions for a drill hole in the front panel are marked simultaneously.

6. The method according to claim 1, wherein the connecting device has at least one fastening device via which the marking device is fastened in a further step, preferably detachably, to and/or in the connecting device.

7. The method according to claim 1, wherein at least one adjustment device is provided, with which the marking device is adjusted in a further step at least in a direction transverse to a longitudinal direction of the drawer side wall relative to the drawer side wall.

8. The method according to claim 1, wherein the at least one front panel is connected to the at least one drawer side wall via the at least one connecting device in such a way that the front side of the drawer side wall contacts at least in portions an inner side of the front panel facing the drawer side wall.

9. The method according to claim 8, further comprising providing at least one drawer extraction guide, preferably wherein at least one coupling device is provided with which the drawer side wall is coupled, preferably detachably, to the drawer extraction guide.

10. The method according to claim 8, further comprising providing at least one drawer bottom connected to the drawer side wall and/or the front panel.

11. The method according to claim 8, further comprising providing at least one rear wall and arranging the rear wall parallel to the front panel, preferably wherein the drawer side wall comprises at least one rear wall holder via which the rear wall is connected to the drawer side wall, preferably detachably.
